(19) United States
(12) Patent Application Publication
(10) Pub. No.: US 2026/0359431 A1
(43) Pub. Date: Nov. 12, 2026

(54) MEMORY REDUCTION VIA DUPLICATIVE DATA ATTRIBUTE PREVENTION

(71) Applicant: Capital One Services, LLC, McLean, VA (US)

(72) Inventors: Jingjie ZHAO, Allen, TX (US); Xu FANG, Frisco, TX (US); Jayakrishna VENKATESH, Frisco, TX (US); Shasha OSTEEN, Flower Mound, TX (US); Casey JONES, Plano, TX (US)

(73) Assignee: Capital One Services, LLC, McLean, VA (US)

(21) Appl. No.: 19/203,001

(22) Filed: May 8, 2025

(51) Int. Cl. G06F 21/55; G06F 9/50

(52) U.S. Cl. CPC G06F 21/554; G06F 9/5016; G06F 2221/034

(57) ABSTRACT

Methods and systems are described herein for reducing memory consumption by preventing duplicative attribute metadata. Some embodiments include determining whether a candidate attribute matches an existing attribute. The existing attributes may include authenticated attributes (e.g., for enterprise-based tasks) and non-authenticated attributes. When new attributes are provided for model-generated metadata to be produced, embodiments described herein enable querying against both authenticated attributes and non-authenticated attributes. Moreover, by generating embeddings representing both attribute names and attribute descriptions, one or more semantically similar attribute names and/or descriptions can be identified and leveraged for generation of standardized attribute metadata.

### BACKGROUND

Data labels are used to store contextual information describing data items. These data labels allow data to quickly and effectively be collected, retrieved, and used for analysis. Inconsistent and non-standardized data labeling is one cause of data attribute duplication, which leads to excessive memory consumption, data misclassification, and data retrieval errors. Further complicating matters is that different data storage components used to store the data are often managed by different entities employing different labeling techniques and conventions, leading to scenarios where the same data item is labeled differently by two different databases. As the data grows in volume and variety, the amount of memory consumed to store the data also increases, further impacting the effectiveness and usefulness of the data labels.

### SUMMARY

However, standardizing data labeling within a metadata ecosystem introduces several technical challenges that must occur to ensure that the correct labels are used and, moreover, duplicative labeling is reduced. One major challenge to preventing duplicative labeling is semantically similar labels stored. For non-enterprise based storage systems, where standardization has not yet occurred, data attribute metadata is stored using a variety of data storage components, each of which may use a separate labeling schema, making detection of similar (or the same) metadata and storing of the metadata computationally expensive. Moreover, sans standardization, more memory will be consumed to store the duplicative data, further increasing costs.

Systems, methods, and programming for metadata creation and management are described. These systems reduce memory consumption by preventing duplicative attribute metadata. This is achieved by generating embeddings for non-authenticated attribute names and descriptions, comparing them against candidate attribute names, and presenting semantically similar options in a graphical user interface for feedback and selection. The technical solutions described here address metadata inconsistencies by establishing a data standardization process that reduces duplicate data attribute names and descriptions while enhancing non-authenticated data attribute metadata. Artificial intelligence models, such as large language models, generate descriptions for both authenticated and non-authenticated data attributes. By generating and searching embeddings for attribute names and descriptions, these solutions capture semantic equivalences beyond exact matches, allowing for the detection of semantically similar, closely related, or exact matches.

In some aspects, a request including a candidate attribute name of a candidate attribute for which a model-generated description is to be produced may be received. Using a first large language model (LLM), a candidate attribute name embedding representing the candidate attribute name may be generated. Based on the candidate attribute name embedding and a plurality of authenticated attribute embeddings, respectively representing a plurality of authenticated attributes, satisfying a duplication condition, (i) first semantic similarity scores may be computed using the candidate attribute name embedding and a plurality of non-authenticated attribute name embeddings and (ii) second semantic similarity scores may be computed using the candidate attribute name embedding and a plurality of non-authenticated attribute description embeddings. A set of semantic similarity scores satisfying a relevant attribute condition may be determined from the first semantic similarity scores and the second semantic similarity scores. Based on the set of semantic similarity scores, a large language model prompt including (a) the candidate attribute name and (b) context comprising at least one of a non-authenticated attribute name or a non-authenticated attribute description corresponding to the set of semantic similarity scores may be generated. The large language model prompt may be input to a second large language model to generate description text data comprising natural language text describing data items labeled with the candidate attribute name.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for reducing memory consumption by preventing data attribute duplication, in accordance with one or more embodiments.

FIGS. 2A-2C show illustrative user interfaces with which candidate attributes and context can be input, context can be selected, and metadata can be generated and refined for data attributes, in accordance with one or more embodiments.

FIG. 3 shows illustrative components for a system used for reducing memory consumption by preventing data attribute duplication, in accordance with one or more embodiments.

FIG. 4 shows a flowchart of the steps involved in reducing memory consumption by preventing data attribute duplication, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Described herein are systems, methods, and programming for reducing memory consumption by preventing duplicative data attribute names and descriptions, authorizing and consolidating unauthorized attribute names and descriptions using large language models, and enhancing network security via standardized and authenticated labeling. Data items can be labeled with metadata to provide additional contextual information regarding the data items'meaning, structure, origin, usage, and the like. However, inconsistent labeling can lead to data misinterpretation, inconsistent data usage, security risks, system integration failures, amongst other problems. This can be exacerbated by siloed databases and repositories, which limits labelers ability to check for duplicative information.

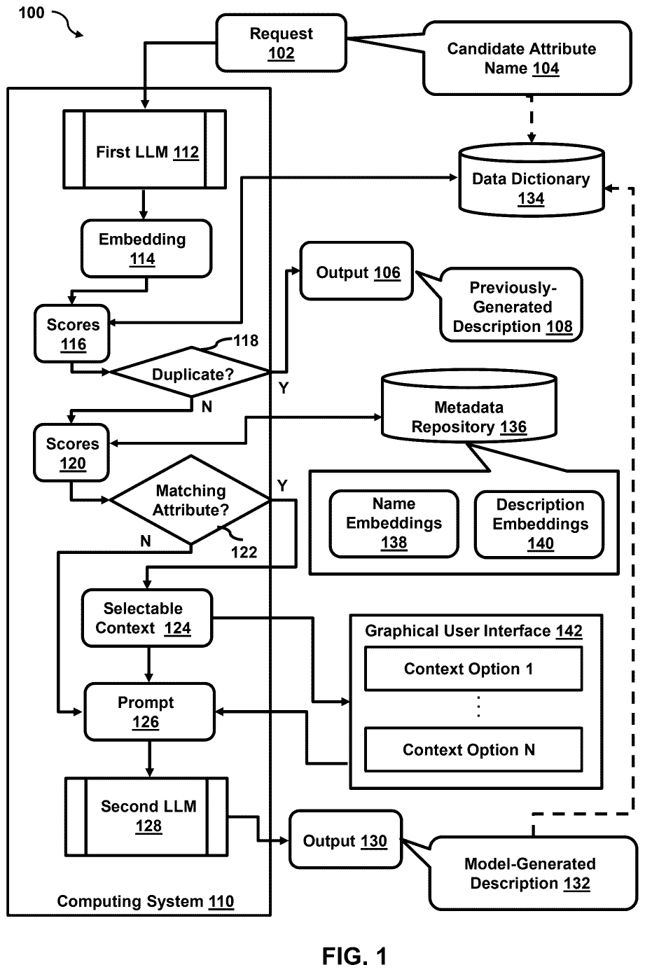

FIG. 1 shows an illustrative system 100 for reducing memory consumption by preventing data attribute duplication, in accordance with one or more embodiments. System 100 can include a computing system 110, which can interact/communicate with one or more devices, servers, APIs, or other systems, via a communication network (e.g., the Internet). Computing system 110 can include hardware, software, and/or cloud-based computing logic, designed and configured to implement various programs and effectively implement various operations.

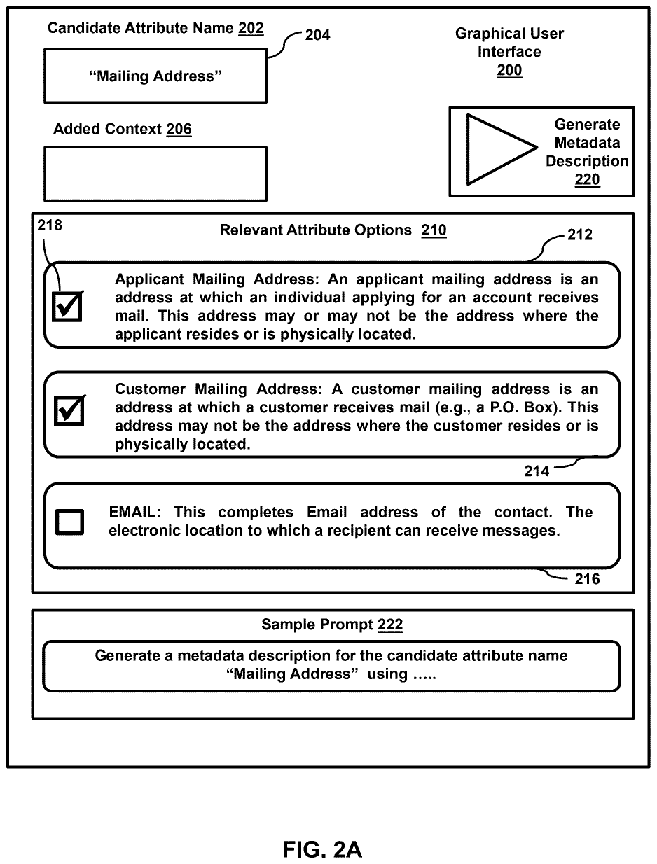

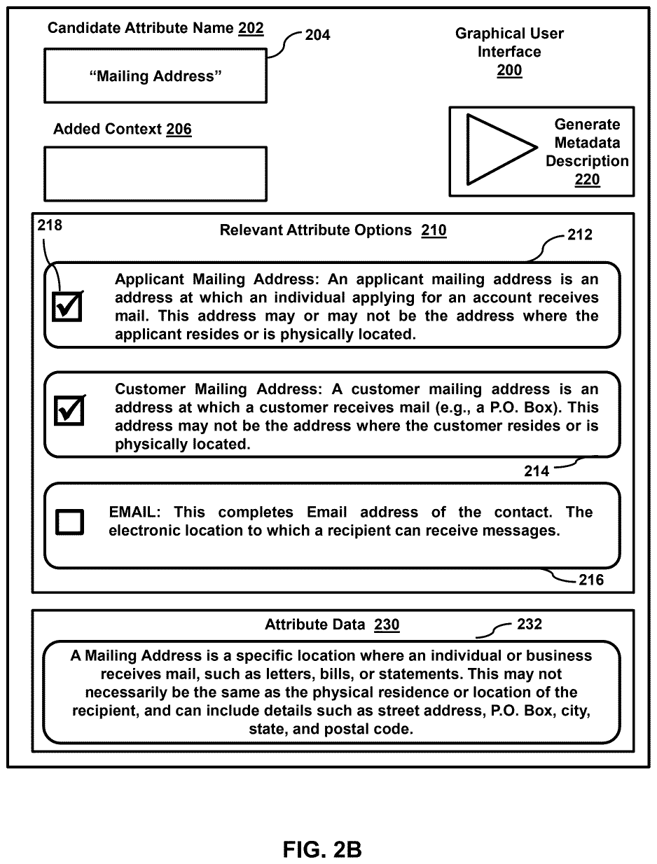

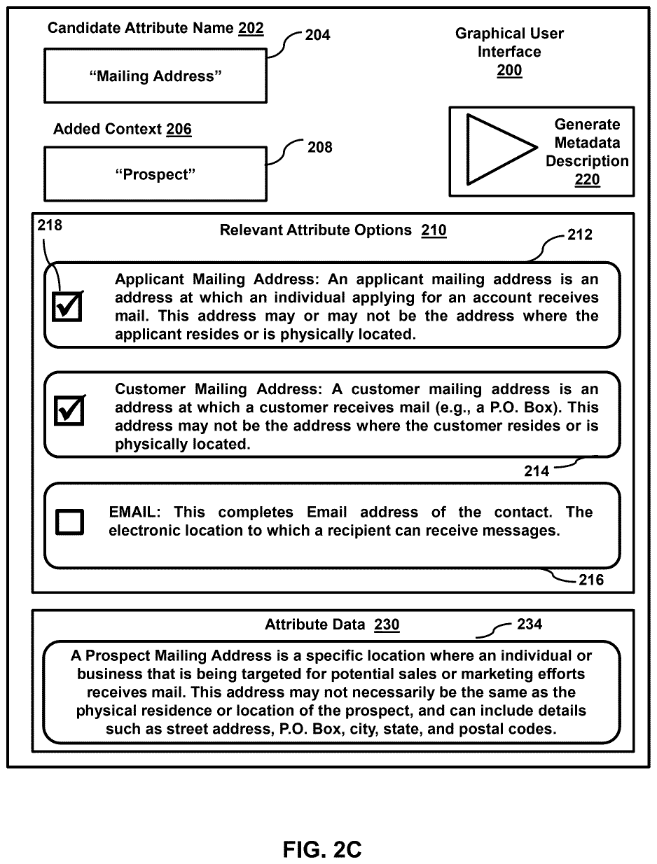

In some embodiments, computing system 110 may be configured to receive a request 102. Request 102 may be received from a client device, such as a mobile device, user terminal, etc. In some examples, a user may seek to have a metadata description generated for an attribute. Request 102 may include a candidate attribute name (e.g., candidate attribute name 104) of a candidate attribute for which a model-generated description is to be produced. As an illustrative example, with reference to FIG. 2A, a graphical user interface 200 can include a candidate attribute name data field 202 for which a user can input a candidate attribute name for which a model-generated metadata description is to be generated. For example, text sequence 204 can be input via candidate attribute name data field 202, indicating that a model-generated metadata description is to be generated for a candidate attribute having a text sequence 204 (e.g., “Mailing Address”) as a corresponding candidate attribute name (e.g., candidate attribute name 104). In some examples, graphical user interface 200 can be rendered on a client device.

Returning to FIG. 1, computing system 110 may be configured to perform functions associated with metadata management, storage, and generation. For example, computing system 110 can function as an enterprise metadata management (EMM) tool. Enterprise computing typically involves scalable, secure, and integrated systems (like ERP, CRM, or data warehouses) designed to handle the needs of an entire organization, rather than just individual users or small teams. In some examples, computing system 110 may be configured to collect, organize, and maintain information about data across an organization. This information-referred to herein as metadata-describes the structure, meaning, and usage of data. For example, the metadata can indicate where the data comes from, what the data means, how the data is/can be used, and how the data connects/relates to other data. Computing system 110 can function as, communicate with, or facilitate interfacing with, a central library/database for the metadata. Alternatively, computing system 110 may communicate with a data dictionary 134 storing authenticated data, authenticated metadata (e.g., authenticated attribute names, authenticated attribute descriptions), rules, logic, or other information that can be used by one or more clients accessing computing system 110.

As an illustrative example, consider a system including multiple data storage devices, such as a first, second, and third database. Each of these databases may be used to store different data, however some data may be similar. For example, one database may include a data item labeled with a first attribute having a first attribute name, while another database can include the data item labeled with the first attribute but having a second attribute name (e.g., one database may refer to a given user using the attribute name “CustID,” while another database may refer to the same user using the attribute name “Customer_Number”). This simple example highlights some of the difficulties labeling data that enterprise networks can help address. For example, the enterprise network, effectuated by computing system 110, can consolidate and map labels to a single, enterprise-approved term, such as “Customer ID,” with a clear definition. This term-definition tuple can be stored in data dictionary 134. Thus, whenever new data is processed, it can be processed in a consistent and standardized manner. Additionally, by leveraging the authenticated data attribute names and data attribute descriptions stored by data dictionary 134, data can be easily tracked and monitored, improving transparency and making errors or inconsistencies easier to detect.

One of the technical problems that occur with non-enterprise systems, which can include hybrid systems (e.g., systems employing enterprise components and non-enterprise components) as well as systems migrating from legacy systems to enterprise systems, is data attribute duplication. Data attribute duplication refers to two or more candidate attribute names being used to describe the same data items. Using the previous example, with both attribute name “CustID” and attribute name “Customer_Number,” which were respectively stored in the first database and the second database, queries for customer identifiers would need to search against both databases using both attribute names (e.g., “CustID” and “Customer_Number”) to obtain the data. Moreover, additional attribute names may be possible, adding more complexity to the process. Data duplication can impact subsequent data labeling operations. For example, the greater the number of attribute names with which a given data attribute can be referenced, the greater the discrepancy in the labeling process that may occur. This can further hamper the labeling process as some labeler-bias can be introduced where one labeler labels a data item using one attribute name while another labeler uses another attribute name for the same or similar data items.

While a naïve solution may be to only leverage data dictionary 134, this restricts the available data from which insights can be derived. As mentioned above, data dictionary 134 may include data structures for authenticated attributes. Each attribute can include its own data structure stored in data dictionary 134. Each data structure can indicate an authenticated attribute name as well as an authenticated attribute description for a corresponding attribute. For example, data dictionary 134 may include authenticated attributes, each including an authenticated attribute name and an authenticated attributed description be approved for use by data labelers while labeling data items. The process of having an authenticated attribute including a corresponding authenticated attribute name and authenticated attribute description may involve multiple stages, multiple layers of approval and verification, and, moreover, can take time to occur. At the same time, valuable information that can be used to improve the labeling of the data (e.g., improving the candidate attribute name and/or candidate attribute description) can be included in data items labeled with non-authenticated attributes.

Non-authenticated attributes refer to attributes whose corresponding non-authenticated attribute name and/or non-authenticated attribute description has/have not yet been authenticated. In other words, data dictionary 134 may not store the authenticated attributes, and therefore labelers of computing system 110 may not be able to apply the non-authenticated attribute names and/or non-authenticated attribute descriptions to existing and/or new data items. In some embodiments, the non-authenticate attributes can be assigned to a given data item along with one or more authenticated attributes.

In some embodiments, attributes, whether authenticated or non-authenticated, can be represented using an attribute name and an attribute description. The attribute name refers to a text string used to identify the attribute, such as when assigning as a label for a data item. For example, the attribute name “CustID” can be stored in a data structure for an attribute called “Customer Identifier.” The attribute name can be human-generated, machine-generated, or partially generated via both human and machine. Similarly, the attribute descriptions can be used to describe the type of data or aspects of the data items being labeled by a given data attribute name. The attribute description may, in some embodiments, be model-generated. For example, one or more artificial intelligence models, such as large language models, may be used to generate attribute descriptions for an attribute. In some examples, large language models can be used to generate text data representing natural language text used for the attribute description. large language models can generate these attribute descriptions based on an attribute name. For example, an attribute name (e.g., “CustID”) can be provided to a large language model with an instruction to generate a metadata description for a data attribute having the attribute name. The metadata description generated by the large language model may be used as the attribute description.

In some embodiments, attribute metadata (e.g., model-generated descriptions) can be produced for new attributes by leveraging non-authenticated attribute metadata. For example, given a candidate attribute name, semantically similar non-authenticated attributes can be identified, which then may be leveraged as context for a large language model to generate metadata for that candidate attribute name. For example, if a candidate attribute to be model has candidate attribute name 104 (e.g., “Customer Identifier”), already-existing attributes, such as a first non-authenticated attribute name “CustID” and a second non-authenticated attribute name “Customer ID,” can provide useful context for the large language model when generating an attribute description for candidate attribute name 104. Moreover, data items labeled with the non-authenticated attribute names can be updated to include the candidate attribute name and the model-generated attribute description produced for the candidate attribute name. This contributes additional technical benefits by providing a standardized way to label data that can be used to improve the labeling of already labeled data items to confirm with new attribute naming conventions and descriptions.

In some embodiments, computing system 110 may be configured to generate a candidate attribute name embedding representing the candidate attribute name. In some examples, a large language model may be used to generate the candidate attribute name embedding. As an example, computing system 110 can provide candidate attribute name 104 to a first large language model (LLM) 112 to generate an embedding 114. For example, first LLM 112 can generate embedding 114 by converting an input text sequence (e.g., candidate attribute name) into a fixed-size vector of numbers that captures the meaning and context of the text. First LLM 112 can tokenize the input into smaller units (like words or subwords), which may be mapped to numerical representations. These tokens can pass through multiple layers of first LLM 112, such as attention mechanisms and neural networks, to learn contextual relationships. Embedding 114 may be output by first LLM 112 as a dense numerical vector that represents the semantic meaning of the input text (e.g., candidate attribute name 104) in a way that can be used for a variety of tasks (e.g., searching, classification, clustering, etc.).

As detailed above, embedding 114, generated by first LLM 112, may represent the semantic meaning of the input text (e.g., candidate attribute name 104) as a dense numerical vector. Embedding 114 can be compared to embeddings representing authenticated attribute names stored in data dictionary 134 to generate scores 116. Similarity scores (e.g., scores 116), thus, indicate how semantically similar the input text of candidate attribute name 104 is to authenticated attribute names of already-existing attributes stored by data dictionary 134. At step 118, computing system 110 may determine, based on scores 116, whether candidate attribute name 104 is the same as any existing attribute names. In some embodiments, computing system 110 may be configured to determine whether the candidate attribute name embedding (e.g., embedding 114) and any of the authenticated attribute name embeddings satisfy a duplication condition. Satisfying the duplication condition can occur when the candidate attribute name matches, to at least a threshold level of confidence, one or more of the authenticated attribute names.

Computing system 110 may compute scores 116 by comparing candidate attribute name embedding 114 to the authenticated attribute name embeddings representing the authenticated attribute names stored in data dictionary 134. Scores 116 can be referred to as similarity scores. For example, embeddings can be compared using various mathematical similarity or distance measures to evaluate how closely related the underlying texts are in meaning. Using these similarity/distance metrics can enable computing system 110 to identify, at step 118, whether two (or more) text sequences (candidate attribute name 104 and the already-existing attribute names of authenticated attributes from data dictionary 134) convey similar concepts, even if the wording is different, recite the same or substantially similar text, do not semantically relate, and the like.

Some example similarity metrics used to determine how similar a given embedding (e.g., embedding 114) is to another embedding include cosine similarity, Euclidean distance, Manhattan distance (L1), and the like. In some embodiments, computing system 110 may analyze scores 116 to determine, at step 118, whether any of scores 116 satisfy a duplication condition. The duplication condition serves to detect whether candidate attribute name 104 is the same or substantially the same as an already-existing attribute name corresponding to an authenticated attribute stored by data dictionary 134 for labeling data. In some examples, the duplication condition at step 118 may be satisfied if a similarity score-comparing embedding 114 and an embedding of an already-existing attribute name of an authenticated attribute-is less than or equal to a threshold similarity score. For example, this can correspond to a scenario where candidate attribute name 104 does not match, to a threshold degree of similarity, any of the known attribute names of authenticated attributes stored by data dictionary 134.

In some embodiments, the threshold similarity score used at step 118 associated with the duplication condition may be differ from other similarity thresholds. For example, the threshold similarity score used for the duplication condition can be greater than other threshold similarity scores, such as those used for identifying partial matches, semantic matches, etc., as the duplication condition serves to identify exact or approximately exact matches. This can include accounting for typographical errors or slight variations in format. For example, the candidate attribute name “Mailng Adderss” may be determined to be a duplication of an already existing attribute name, “Mailing Address,” despite the spelling errors. Some example threshold similarity scores associated with the duplication condition include 90% or greater, 95% or greater, 99% or greater, and the like.

In some embodiments, if at step 118, computing system 110 determines that the duplication condition failed to be satisfied (i.e., candidate attribute name 104 is a duplicate), then this can indicate that the candidate attribute name (e.g., candidate attribute name 104) matches, to at least a threshold level of confidence (e.g., 90% or greater, 95% or greater, 99% or greater, etc.), one (or more) of the authenticated attribute names stored in data dictionary 134. Computing system 110 may be configured to determine an authenticated attribute name embedding corresponding to the similarity score that failed to satisfy the duplication condition (e.g., whose similarity score was greater than the duplication threshold similarity score). The authenticated attribute name embedding can be used to determine an authenticated attribute whose corresponding authenticated attribute name matches the candidate attribute name (e.g., candidate attribute name 104).

In some embodiments, computing system 110 may be configured to provide, via a graphical user interface, a graphical representation (e.g., output 106) of the matching authenticated attribute including the authenticated attribute name and a corresponding authenticated attribute description. For example, computing system 110 may be configured to generate an output 106 including a previously-generated description 108 of the matching authenticated attribute. The graphical user interface may include, for example, one or more selectable options to select the authenticated attribute name (e.g., the already-existing attribute name determined to match candidate attribute name 104) and the corresponding authenticated attribute description (e.g., previously-generated description 108) for use as a label for data items.

In some embodiments, the duplication condition can include an option to use semantic similarity to identify duplications. For example, scores 116 may be compared to a second threshold similarity score (e.g., 80% or greater, 85% or greater, 90% or greater) to determine how semantically similar a candidate attribute name (e.g., candidate attribute name 104) is to the already-existing attribute names. In this example, the graphical user interface can display each already-existing attribute name determined to satisfy the second threshold similarity condition, enabling user selection (or no selection) of any of the identified existing attribute names.

In some embodiments, based on the duplication condition being satisfied at step 118 (e.g., candidate attribute name 104 was not determined to be a duplication of any authenticated attribute names), computing system 110 may be configured to compute similarity scores 120. Similarity scores 120 may differ from scores 116 in that the comparison performed at step 122 may be a determination of whether candidate attribute name 104 matches any non-authenticated attribute names and/or any non-authenticated attribute descriptions. For example, metadata repository 136 may be configured to store non-authenticated attributes and attribute metadata. This information may not yet have received authorization from one or more systems, administrators, or other mechanisms, to authorize and approve the use of a given candidate attribute name and/or candidate attribute description as an approved data label. However, this information nonetheless can include valuable contextual information that can be leveraged to generate a candidate attribute description for the candidate attribute name, as well as standardize other similar candidate attributes.

In some embodiments, metadata repository 136 may be configured to store data structures associated with non-authenticated attributes. For example, metadata repository 136 can include, for a plurality of non-authenticated attributes, non-authenticated attribute names and non-authenticated attribute descriptions for those names. The non-authenticated attribute names and descriptions may include natural language text. For example, the non-authenticated attribute name can be represented by a text string (e.g., “Customer Mailing Address”). As another example, the non-authenticated attribute description can be represented by one or more text strings (e.g., sentences, paragraphs, etc.).

In some embodiments, the non-authenticated attribute names and descriptions can have respective embeddings generated—such as name embeddings 138 and description embeddings 140. In some examples, non-authenticated attribute names and/or non-authenticated attribute descriptions stored in metadata repository 136 can be input to first LLM 112 or another similar artificial intelligence model to generate name embeddings 138 and description embeddings 140, respectively. The embeddings can be generated dynamically at run time and/or stored in memory (e.g., metadata repository 136).

Separating the embeddings for non-authenticated attribute names and non-authenticated attribute descriptions can improve the searching power, facilitating greater scope and higher likelihood of identifying similar attributes. For example, candidate attribute name 104 may not match any non-authenticated attribute name, but one or more non-authenticated descriptions may be determined to be semantically related.

For example, computing system 110 may compute scores 120 (e.g., semantic similarity scores) using the candidate attribute name embedding (e.g., embedding 114), a plurality of non-authenticated attribute name embeddings (e.g., name embedding 138), and a plurality of non-authenticated attribute description embeddings (e.g., description embeddings 140). In some embodiments, similarity scores 120 may include first semantic similarity scores and second semantic similarity scores. For example, the first semantic similarity scores may refer to semantic similarity scores computed based on embedding 114 and name embeddings 138, while the second semantic similarity scores may refer to semantic similarity scores computed based on embedding 114 and description embeddings 140. In some embodiments, scores 120 may be computed using analogous similarity metrics as that described above with reference to scores 116, however alternative and/or additional similarity metrics may be used. In some embodiments, similarity scores 120 may include a semantic similarity computation that identifies similar meanings between text strings, an alignment computation that determines how closely one text string supports another text string, or other metrics, or combinations thereof.

In some embodiments, at step 122, computing system 110 may be configured to determine a set of similarity scores satisfying a relevant attribute condition. The set of semantic similarity scores may be determined from scores 120. For example, the set of similarity scores may be selected from the first semantic similarity scores and the second semantic similarity scores. In some embodiments, the set of similarity scores may be selected regardless of whether they are from the first semantic similarity scores or the second semantic similarity scores. In some embodiments, the set of similarity scores may be selected such that at least one similarity score from the first semantic similarity scores and the second semantic similarity scores are chosen. In some embodiments, the set of similarity scores may include at least one similarity score, from either the first or second semantic similarity scores.

In some embodiments, satisfying the relevant attribute condition may include determining whether candidate attribute name 104 matches any non-authenticated attribute name. In some embodiments, the relevant attribute condition can be analyzed by computing a distance in embedding space between embedding 114 representing candidate attribute name 104 and some or all of name embeddings 138 representing non-authenticated attribute names stored by metadata repository 136. If the distance between embedding 114 and one (or more) of name embeddings 138 is determined to be less than a threshold distance, then this can indicate that embedding 114 is semantically similar to that non-authenticated attribute name. Embeddings that are “close” to one another in an embedding space indicate that the text strings that these embeddings represent are semantically similar. Non-authenticated attribute names determined to be semantically similar (e.g., based on scores 120) to candidate attribute name 104 can be selected as a possible context option for metadata generation for an attribute having candidate attribute name 104.

In some embodiments, the relevant attribute condition can be analyzed by computing an alignment score. The alignment score indicates how well an attribute description describes an attribute name. For example, a non-authenticated attribute description may be said to describe an attribute name when the description logically can be interpreted as a true and contextually accurate explanation, example, or other written support for a sequence of text represented by that corresponding attribute name. This can be helpful to distinguish away from situations where generated descriptions, such as model-generated descriptions leveraging pre-training data, appear true but are not aligned with the input prompt. Non-authenticated attribute descriptions determined to align and/or be semantically similar to candidate attribute name 104 can be selected as a possible context option for metadata generation for an attribute having candidate attribute name 104.

In some embodiments, at step 122, if computing system 110 determines, based on scores 120, that none of the non-authenticated attribute names or descriptions relate to candidate attribute name, candidate attribute name 104 can be provided to a second LLM 128 to generate an output 130 including a model-generated description 132. For example, computing system 110 may determine at step 122 that none of scores 120 exceed a threshold similarity score. This similarity threshold may be used to determine relevant attributes and can be less than that used to identify duplication. As an illustrative example, if a first threshold similarity score used for the duplication condition is a score of 95% (e.g., indicating two text strings are 95% similar), a second threshold similarity score used for the relevant attribute condition may be a score of 80% (e.g., indicating that two text strings are 80% similar).

In some embodiments, at step 122, computing system 110 may perform separate comparisons against non-authenticated attribute names and non-authenticated attribute descriptions. For example, embedding 114 may be compared against name embeddings 138 to determine whether any non-authenticated attribute names are semantically similar (or the same) to candidate attribute name 104. This comparison can include computing system 110 determining a distance in embedding space between embedding 114 and each of name embeddings 138. If the distance is less than a threshold distance, then this can indicate that the corresponding non-authenticated attribute name matches candidate attribute name 104. As another example, embedding 114 may be compared to description embeddings 140 to determine whether candidate attribute name 104 aligns with any non-authenticated attribute descriptions. This comparison can include computing system 110 computing an alignment score (e.g., a Levenshtein Distance, a Jaccard Index, an F1 score, etc.) using embedding 114 and description embeddings 140.

In some embodiments, non-authenticated attribute names determined to satisfy the relevant attribute condition at step 122 may include non-authenticated attribute descriptions that did not satisfy the relevant attribute condition. Similarly, non-authenticated attribute descriptions determined to satisfy the relevant attribute condition at step 122 may include non-authenticated attribute names that did not satisfy the relevant attribute condition. As an illustrative example, a first non-authenticated attribute stored in metadata repository 136 may include a first non-authenticated attribute name and a first non-authenticated attribute description. At step 122, computing system 110 may compute a first score indicating how similar candidate attribute name 104 is to the first non-authenticated attribute name and a second score indicating how well the first non-authenticated attribute description describes candidate attribute name 104. If, for example, the first score is determined to be greater than a first threshold score, indicating a match between candidate attribute name 104 and the first non-authenticated attribute name, but the second score is determined to be less than a second threshold score, indicating no match between candidate attribute name 104 and the first non-authenticated attribute description, then the first non-authenticated description may also be selected with the first non-authenticated attribute name as possible context options. As another example, if the second score is determined to be greater than the second threshold, indicating that the first non-authenticated attribute description describes candidate attribute name 104, but the second score is less than the first threshold, indicating that the first non-authenticated attribute name was not determined to match candidate attribute name 104, then the first non-authenticated attribute name may also be selected with the first non-authenticated attribute name as possible context options.

In some embodiments, weights may be applied to any of the non-authenticated attributes whose corresponding name and/or description matches candidate attribute name 104. The weights may be dependent on the corresponding score. Computing system 110 may be configured to assign one or more first weights to a first set of similarity scores from the first plurality of similarity scores. For example, a first weight may be applied to non-authenticated attribute names and/or descriptions determined to satisfy the relevant attribute condition. Computing system 110 may be configured to assign second weights to a second set of similarity scores from the second plurality of similarity scores. For example, a second weight may be applied to non-authenticated attribute names and/or descriptions that were determined to not satisfy the relevant attribute condition but whose corresponding non-authenticate attribute descriptions and/or names, respectively, did satisfy the relevant attribute condition.

In some embodiments, computing system 110 may be configured to select the set of semantic similarity scores based on the first set of similarity scores having the first weights and the second set of similarity scores having the second weights. Satisfying the relevant attribute condition may include a weighted similarity score being greater than or equal to a threshold similarity score.

In some embodiments, computing system 110 may be configured to determine, at step 122, whether the weighted similarity score is greater than or equal to a threshold similarity score. In some examples, the threshold similarity score can be computed based on the threshold score used for comparisons against non-authenticated attribute names and the threshold score used for comparisons against non-authenticated attribute descriptions. For example, a first threshold similarity score may be used to identify matches between embedding 114 representing candidate attribute name 104 is name embeddings 138 representing the non-authenticated attribute names stored by metadata repository 136. A second threshold similarity score may be used to identify matches between embedding 114 representing candidate attribute name 104 is description embeddings 140 representing the non-authenticated attribute descriptions stored by metadata repository 136. In this example, the threshold similarity score may be determined based on a weighted combination of the first threshold similarity score and the second threshold similarity score.

If any of scores 120 are determined to satisfy the relevant attribute condition (e.g., at step 122), the corresponding non-authenticated attribute names and/or descriptions may be provided as selectable context 124 for prompt generation (where the prompt is used by second LLM 128 to generate output 130). Selectable context 124 can be provided to a client device via a graphical user interface 142. Graphical user interface 142 can include context options 1-N (e.g., top-K options) that can be selected and used as context, or used to create context, for prompt 126. For example, and as detailed below, a user can select, via graphical user interface 142, one or more non-authenticated attribute names and/or descriptions that are relevant to the creation of a metadata description representing candidate attribute name 104.

As an example, with reference to FIG. 2A, graphical user interface 200 may include relevant attribute options 210. Relevant attribute options 210 may include graphical representations of non-authenticated attribute names and non-authenticated attribute descriptions determined to satisfy the relevant attribute condition. For example, a non-authenticated attribute name (e.g., Applicant Mailing Address, Customer Mailing Address, Email Address, etc.) can be identified as being similar to candidate attribute name 104 (as represented by text sequence 204) and included as one of relevant attribute options 210.

As illustrated in FIG. 2A, relevant attribute options 210 may include a first selectable context option 212, a second selectable context option 214, and a third selectable context option 216. While only three example context options are depicted, persons of ordinary skill in the art will recognize other quantities of example context options may be included. Each of the selectable context options 212-216 can include a selectable radio button 218. In some examples, selection of radio button 218 can highlight, or add a check mark, or display another feature to signify that a corresponding context option has been selected. For example, first selectable context option 212 and second selectable context option 214 may be selected, while third selectable context option 216 was not. Alternative mechanisms for selecting options 212-216 can be used instead of or in addition to radio buttons 218. Each selectable context option can represent one of the non-authenticated attributes determined as possible to match candidate attribute name 104.

In some embodiments, relevant attribute options 210 may include top-K results. For example, the top-K similarity scores (e.g., at step 122 of FIG. 1) can be identified. From the top-K, some or all of the corresponding non-authenticated attribute names and/or descriptions can be provided as options for context to use for metadata generation. As an example, the illustrative embodiment includes three selectable context options 212-216. Thus, in this example, these options would correspond to the top-3 results (similarity scores 120). However, alternative selection criteria can be used.

In some embodiments, computing system 110 may default to leveraging all relevant attribute options 210. For example, if no user selection is received or provided to refine relevant attribute options 210, computing system 110 may be configured to use all of the available context options (e.g., selectable context options 212-216) as relevant context for a large language model prompt (e.g., prompt 126) used to generate metadata describing candidate attribute name 104. As another example, if no user selection is received, computing system 110 may be configured to not use any of selectable context options 212-216 to generate context for a large language model prompt to generate metadata describing candidate attribute name 104. As another example, if no user selection is made, a selectable context option associated with the greatest similarity score may be selected.

In some embodiments, graphical user interface 200 may be provided to a client device for user selection of some, none, or all of relevant attribute options 210. A user may be presented with graphical user interface 200 rendered on their client device, and can select, using radio buttons 218, any or none of selectable context options 212-216. For example, as seen in FIG. 2A, first selectable context option 212 and second selectable context option 214 may be selected by a user for metadata description generation. By selecting options 212 and 214, the non-authenticated attribute names (e.g., Applicant Mailing Address, Customer Mailing Address) and their corresponding descriptions can be used as context by second LLM 128 to generate a metadata description for candidate attribute name 104. Advantageously, this description leverages existing knowledge (e.g., non-authenticated attribute names and descriptions) to improve the quality of the description that is produced. Moreover, relevant attribute options 210 enables the user to not include existing non-authenticated attribute names and descriptions that are not to be used to generate the metadata description. For example, selectable context option 216 may be syntactically related to candidate attribute name 104, but semantically different.

Not only does this enhance the quality of the metadata produced for a candidate attribute, but by identifying similar attribute metadata (e.g., similar non-authenticated attribute data), an overall more encompassing and descriptive set of information can be generated and stored for a given data item. Moreover, as the newly-generated attribute name and description may be capable of describing more data than the previously-used non-authenticated attribute names/descriptions and/or authenticated attribute names/descriptions, less data storage is needed. For example, by reducing exact duplications, as well as semantically similar copies, of attribute metadata, significant storage saving can be attained. Moreover, more accurate labeling can be performed for data items, which reduces computational resources consumed for data item querying and retrieval, downstream data operations and transformations, and deriving insights from data analytics.

Returning to FIG. 1, in some embodiments, computing system 110 may be configured to generate a large language model prompt (e.g., prompt 126). The large language model prompt may be generated based on the set of semantic similarity scores (e.g., a set of scores from scores 120 that satisfy the relevant attribute condition). In some examples, prompt 126 (e.g., a large language model prompt) may include candidate attribute name 104. In some examples, large language model prompts may include context. The context can include, for instance, a non-authenticated attribute name, a non-authenticated attribute description, or a combination thereof, corresponding to the set of semantic similarity scores. The context may also include user-provided context, such as text, images, video, files, links, etc.

As an example, with reference to FIG. 2A, graphical user interface 200 may include a selectable option 220 to cause a metadata description to be generated. In particular, invocation of selectable option 220 can cause a large language model prompt (e.g., large language model prompt 126) to be generated. This large language model prompt can serve as an input to a large language model (e.g., second LLM 128) to generate metadata descriptions. For example, the large language prompt can include any of the selected relevant attributes options 210 as context, with the instruction/query corresponding to a request (e.g., request 102) to generate a metadata description for the text sequence associated with candidate attribute name 104.

In some embodiments, computing system 110 generating large language model prompt 126 may include creating the large language model prompt to include a query text sequence representing the candidate attribute name and a context text sequence representing one or more selected non-authenticated attribute names and/or the non-authenticated attribute descriptions. For example, generating the large language model prompt may include computing system 110 determining a subset of non-authenticated attribute names and a subset of non-authenticated attribute descriptions corresponding to the set of semantic similarity scores (e.g., one or more of scores 120 that satisfy the relevant attribute condition). The subset of non-authenticated attribute names and the subset of non-authenticated attribute descriptions may be provided (e.g., to a client device) via a graphical user interface. In some embodiments, computing system 110 may be configured to detect, via the graphical user interface, a selection of one of the non-authenticated attribute names and/or the non-authenticated attribute descriptions. The selected non-authenticated attribute names and/or non-authenticated attribute descriptions can be used to generate the large language model prompt. For example, the non-authenticated attribute names and descriptions from selectable context options 212 and 214 can be included in large language model prompt 126.

In some embodiments, computing system 110 determining the set of similarity scores satisfying the relevant attribute condition can include determining a quantity of samples to include as selectable options for context. The set of semantic similarity scores can be selected such that the set has a quantity equal to the quantity of samples. In some examples, the set of semantic similarity scores can be selected based on the first semantic similarity scores and the second semantic similarity scores (e.g., a top-K semantic similarity scores). In some embodiments, an option may be included to obtain a selection of the next top-K results, or another quantity of alternative results.

Returning to FIG. 1, upon receiving the selection of one or more context options (e.g., presented by graphical user interface 142), computing system 110 can generate prompt 126. The prompt, for example, may include a query portion and a context portion. The query portion can include an instruction to generate natural language text to describe a text string representing a candidate attribute name (e.g., candidate attribute name 104). The instruction can include rules, formatting guidelines, or other parameters to be used by second LLM 128 when generating attribute metadata (e.g., some or all of the selectable context options).

In some embodiments, computing system 110 may be configured to input the large language model prompt (e.g., prompt 126) to a second large language model (e.g., second LLM 128). The second large language model may be trained to generate text descriptions. For example, second LLM 128 may take, as input, the large language model prompt, and generate description text data (e.g., output 130 including model-generated description 132). The description text data may include natural language text describing data items labeled, or to be labeled, with the candidate attribute name.

In some embodiments, computing system 110 inputting the large language model prompt (e.g., prompt 126) to the second large language model (e.g., second LLM 128) may include retrieving metadata rules associated with the natural language text. These metadata rules can specify a structure and format of the natural language text. In some embodiments, the metadata rules can include an instruction to include the weightings associated with selectable context options 212 and 214 when generating the output.

As an illustrative example, with reference to FIGS. 2A and 2B, options 212 and 214 of relevant attribute options 210 may be selected for use as context. In some embodiments, graphical user interface 200 may include selectable option 220, whose invocation can cause the large language prompt to be generated. Furthermore, selection of option 220 may cause the large language model prompt to be input to second LLM 128. In some embodiments, the large language model prompt (e.g., prompt 126) can be displayed within graphical user interface 200. For example, as seen in FIG. 2A, sample prompt 222 can be displayed within graphical user interface 200. By displaying sample prompt 222 prior to being input to second LLM 128, edits and/or modifications (e.g., additional context) can be included. In some embodiments, the large language model prompt (e.g., prompt 126) can be input to second LLM 128 upon generation (e.g., in response to invoking option 220).

In some embodiments, as mentioned above, second LLM 128 may be trained to generate text descriptions (e.g., attribute metadata) to describe an attribute based on the large language model prompt. In some examples, as illustrated in FIG. 2B, second LLM 128 may generate attribute data 230 including a model-generated description 232. Model-generated description 232 can include natural language text. However, some embodiments include model-generated description 232 including images, video, audio, or other data formats, or combinations thereof. In some examples, model-generated description 232 may be generated based on selectable context options 212 and 214 being chosen for inclusion as context for prompt 126.

In some embodiments, computing system 110 may be configured to provide, to a client device, the description text data. For example, the natural language text may be displayed via graphical user interface 200 as model-generated description 232. As can be seen from model-generated description 232, second LLM 128 leveraged information from selected context options 212 and 214. If no relevant attribute options 210 were selected, second LLM 128 may have created a different description that lacked contextually relevant information, such as that included by relevant attribute options 210.

Graphical user interface 200, rendered using hardware and software components of the client device, can be used to detect additional inputs and/or user feedback for the natural language text. For example, with reference to FIGS. 2B and 2C, graphical user interface 200 may include a data field 206 where an input can be provided. This input can represent additional context added by a user to assist with the large language model generating the metadata description and/or improve the results produced thereby. For example, as seen in FIG. 2B, data field 206 may not include an input. Therefore, model-generated description 232 may have been generated using an input large language prompt including a query formed from text sequence 204 (e.g., “Mailing Address”) and the selected relevant attributes options 210. If additional context is to be provided, that context can be input via data field 206.

As an example, with reference to FIG. 2C, data field 206 includes text sequence 208 (e.g., “Prospect”), which can be provided as part of an updated large language model prompt. Moreover, this updated large language model prompt can cause second LLM 128 to generate a different model-generated description 234. In particular, model-generated description 234 can be formed based on the candidate attribute name input to data field 202, additional context input to data field 206, and relevant non-authenticated attribute information selected from relevant attribute options 210.

Returning to FIG. 1, model-generated description 132 of output 130 can be provided to the client device (e.g., that submitted request 102). For example, a graphical user interface (e.g. graphical user interface 200) can be used to display model-generated description 132. In some embodiments, a user may be able edit the natural language text included by model-generated description 132. For instance, a user can input additional information (e.g., into data field 206), select additional or different contextual information (e.g., selecting different relevant attribute options 210), provide edits/modifications to model-generated description 132, and the like. For example, using the graphical user interface (e.g., graphical user interface 200), computing system 110 can detect an input or selection. The input or selection can provide additional information, corrections, support, style, or other facets to the model-generated description.

In some embodiments, computing system 110 may be configured to generate an updated large language model prompt based on the large language model prompt, the natural language text, and the user feedback. For example, upon receiving model-generated description 132, a user may edit one or more words, phrases, or other items. These edits can be used to generate an updated large language model prompt. The updated large language model prompt can be input, using computing system 110, to second LLM 128 to obtain updated description text data (e.g. representing an updated model-generated description). The updated description text data can include, for example, updated natural language text. This updated natural language text can be used to describe data items labeled with the candidate attribute name (e.g., label metadata).

In some embodiments, computing system 110 may be configured to determine an alignment score for the natural language text (e.g., model-generated description 132) indicating how closely the natural language text aligns with the context included by the large language model prompt (e.g., prompt 126). If the alignment score is determined to be greater than or equal to an alignment threshold score, then this can indicate that the natural language text aligns with the context. Therefore, computing system 110 may provide the natural language text as an attribute description for the candidate attribute. For example, the candidate attribute name and natural language text may be stored for validation and possible use in labeling data items.

If, however, the alignment score is determined to be less than an alignment score threshold, indicating that the natural language text fails to align with the context, computing system 110 may be configured to generate an updated large language model prompt. For example, if model-generated description 132 is not supported by selectable context 124, then this could indicate that second LLM 128 leveraged pre-training memory or other sources to generate output 130 instead of the context. The updated large language model prompt may include additional context. For example, additional context can be added (e.g., adding the text sequence “Prospect” in data field 206 of FIG. 2C) to the prompt. In some embodiments, computing system 110 may be configured to input the updated large language model prompt to second LLM 128 to generate updated description text data. For example, the updated description text data may include updated natural language text. This updated natural language text can represent an updated model-generated description for the candidate attribute name.

In some embodiments, model-generated description 132 can be paired and stored with candidate attribute name 104 as a metadata description. For example, upon creation and validation (which may include one or more human-based reviewers, tests, or other procedures), the candidate attribute that candidate attribute name 104 is to represent can be stored, with model-generated description 132, as an authenticated attribute. In some embodiments, an authenticated attribute being added to data dictionary 134 may include generating and storing a data structure for the candidate attribute. This data structure can store candidate attribute name 104 and model-generated description 132. When new data items are received by computing system 110, computing system 110 may be configured to label those data items using one or more authenticated attributes. Thus, For example, if the data item received can be labeled with the candidate attribute name (indicating that the data item has the same class or type as that of the candidate attribute), then the candidate attribute may be similar to the received data item. To label a data item with an attribute means to assign a specific piece of information or a descriptor (e.g., candidate attribute name 104, model-generated description 132) to that item, giving it additional context or meaning. Attributes help organize, categorize, and make data easier to search, filter, and analyze.

In some embodiments, first LLM 112 may be trained to generate embeddings (e.g., embedding 114) by learning to represent text sequences (e.g., candidate attribute name 104) as dense numerical vectors that capture their meaning, context, and relationships. First LLM 112 trains on massive amounts of text data to learn patterns through tasks like predicting the next word in a sentence (causal language modeling) or filling in missing words (masked language modeling). As first LLM 112 processes input text, first LLM 112 passes the tokenized words through multiple layers of neural networks-such as transformers-where each layer builds a deeper, more abstract understanding of the text's structure and meaning. The hidden states produced by these layers, especially from the deeper layers, can serve as the text's embeddings. Doing so can enable first LLM 112 to learn to position semantically similar texts close together in the embedding space, even if they use different words. For example, text sequences like “I'm feeling happy” and “I'm in a good mood” would have embeddings that are close to each other, reflecting their similar meaning. First LLM 112 can optimize these representations during training by minimizing a loss function that encourages meaningful clustering of related text and separation of unrelated text. Once trained, first LLM 112 can quickly generate embeddings for new inputs, enabling tasks like semantic search, text classification, or clustering based on the embedded representations.

In some embodiments, computing system 110 may be configured to train a second LLM 128. For example, second LLM 128 may be trained by iteratively providing training prompts to the second large language model to generate training descriptions. An alignment score can be determined based on how closely the training descriptions align with ground truth descriptions associated with the training prompts. One or more parameters of second LLM 128 may be adjusted to minimize a loss function. For example, the loss function can describe how closely a given training description aligns with a corresponding ground truth description.

Second LLM 128 may be trained to generate plain text descriptions, such as model-generated description 132, by learning to predict and compose coherent, human-like language based on input text sequences. During training, second LLM 128 may be provided with large quantities of datasets that include pairs of input texts and their corresponding descriptions, summaries, or explanations. Second LLM 128 can learn by performing tasks like next-word prediction, sequence generation, and instruction following, adjusting its internal parameters to minimize a loss function that measures how close its output is to the expected description. Over time, second LLM 128 can build an understanding of how to identify important information in the input and express it clearly and naturally.

As part of this process, second LLM 128 also learns to assess alignment between the input text and its generated output. During training, second LLM 128 may be rewarded when the generated description captures the correct meaning, key elements, and relationships from the input, and penalized when it introduces irrelevant or incorrect information. Techniques like token-level loss measurement, attention mechanisms, and, in more advanced setups, reinforcement learning from human feedback (RLHF) help second LLM 128 refine its ability to stay aligned. This ensures that the descriptions second LLM 128 produces are not just fluent, but also faithful and accurate representations of the original text, improving the overall reliability and usefulness of second LLM 128's outputs.

In some embodiments, computing system 110 may be configured to label data items using one or more authenticated attributes. If a first data item to be labeled is received, a determination of a most appropriate authenticated attribute can be used to assign labels to the first data item. For example, computing system 110 may be configured to determine that the first data item is to be labeled with the candidate attribute. In this example, the first data item can be stored with the candidate attribute name and natural language text. For example, the first data item can include the candidate attribute name as a label of a type of data item.

In some embodiments, computing system 110 may be configured to facilitate one or more data operations to be performed to, or using, the labeled data. For example, computing system 110 may be configured to receive a request to execute data insight operations. In response to receiving the request, computing system 110 may determine one or more attribute names to be analyzed based on the request. If the request identifies the candidate attribute as relevant, the first data item may be retrieved based on the first data item having the candidate attribute name stored therewith as a label. Thus, computing system 110 may be configured to execute the data insight operations to one or more data items including the first data item, where these data items include the candidate attribute name as a label indicating that these data items correspond to the candidate attribute.

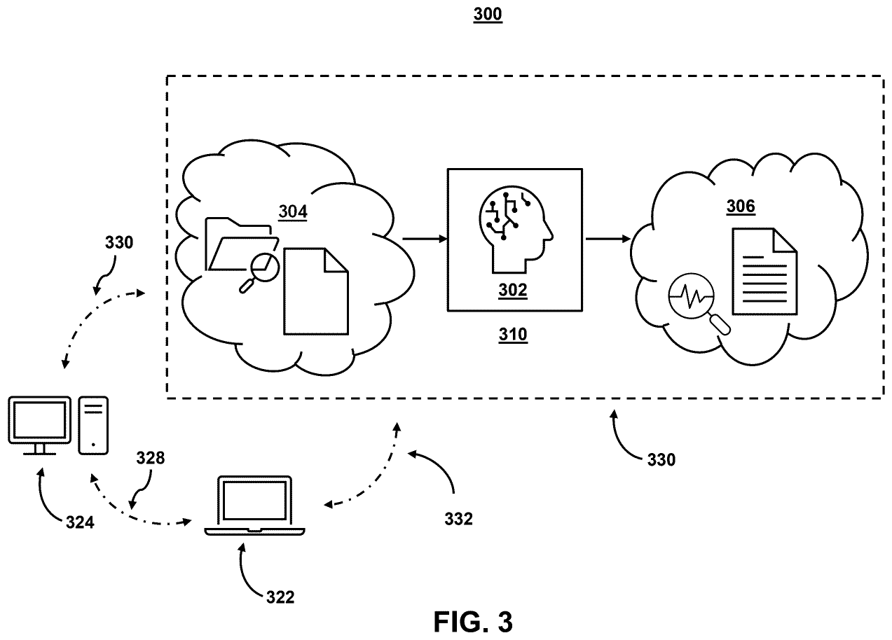

FIG. 3 shows illustrative components for a system used for reducing memory consumption by preventing data attribute duplication, in accordance with one or more embodiments. As mentioned above, technical problems exist in network computing environments when managing, storing, and updating data, such as with respect to data labeling tasks. For example, these technical problems can include metadata inconsistencies, governance inefficiencies, and challenges in data standardization. Additionally, these technical problems result in further challenges with respect to memory consumption. Without standardization, duplicative attributes can be generated, stored, and used for data item labeling, leading to mislabeled/inconsistent data searching and retrieval, incorrect data analytics, and overused memory.

To address these issues, the technical solutions described herein provide metadata management to facilitate automated metadata creation, review, approval, and quality assurance. Moreover, the techniques described herein can streamline the creation of a standardized data ecosystem as well as integration of generative artificial intelligence with semantic search and Retrieval-Augmented Generation (RAG) to standardize metadata generation, validation, and governance processes. These technical solutions contribute numerous technical benefits, such as ensuring consistency and standardization of metadata definitions, reducing errors by leveraging enterprise knowledge via RAG, and decreasing the manual workload associated with metadata documentation. Furthermore, the technical solutions improve metadata quality by identifying related attributes across existing metadata sources and enhance efficiency of governance by reducing computational resources expended and ensuring compliance with regulatory requirements. Moreover, by reducing data attribute duplication, memory that would otherwise be consumed by duplicative data can be freed for other uses.

As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., graphical user interface 200 of FIGS. 2A-2C).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storage. The electronic storage may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing systems and devices may be implemented by a cloud of computing platforms operating together as the computing devices.

Cloud components 310 may include one or more components of computing system 110, In some embodiments, one or more of cloud components 310 may be used to define and manage cloud-based memory. For example, data dictionary 134, metadata repository 136, and/or other data storage components can be implemented using cloud-based memory.

Cloud components 310 may access one or more databases (e.g., data dictionary 134, metadata repository 136) In some examples, cloud components 310 may access a cloud-based memory.

Cloud components 310 may include model 302, which may be a machine learning model, artificial intelligence model, etc. (which may be referred collectively as “models” herein). For example, first LLM 112 and/or second LLM 128 can be implanted using a model that is the same or similar to model 302. Model 302 may take inputs 304 and provide outputs 306. For example, in the case of first LLM 112, inputs 304 may include requests, such as request 102, and outputs 306 may include embeddings, such as embedding 114. As another example, in the case of second LLM 128, inputs 304 may include prompts, such as prompt 126, and outputs 306 may include model-generated descriptions, such as model-generated description 132.

In the case of training data for training first LLM 112, inputs 304 may include multiple data sets, such as a training data set, a test data set, validation data set, etc. Each of the plurality of data sets (e.g., inputs 304) may include data subsets related to input requests including candidate attribute names or other text sequences, as well as reference embeddings serving as ground truth representations of those candidate attribute names or text sequences. In some embodiments, outputs 306 may include embeddings generated by first LLM 112 to represent the input requests (e.g., including the candidate attribute names and text sequences).

In the case of training data for training second LLM 128, inputs 304 may include multiple data sets, such as a training data set, a test data set, validation data set, etc. Each of the plurality of data sets (e.g., inputs 304) may include data subsets related to input large language model prompts, as well as reference descriptions serving as ground truth representations of those prompts. The reference descriptions may be model-generated descriptions (e.g., using a verified LLM). The reference descriptions may also include human-generated descriptions (e.g., created by a subject matter expert) and/or model-generated descriptions modified by subject matter experts. In some embodiments, outputs 306 may include model-generated descriptions generated by second LLM 128 to represent the input large language model prompts.

In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., evaluation metric scores and/or model performance scores).

In some embodiments, the model (e.g., model 302) may automatically perform actions based on outputs 306. In some embodiments, the model (e.g., model 302) may not perform any actions. The output of the model (e.g., model 302) may be used to evaluate the trained large language model on the task it has been fine-tuned to perform).

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

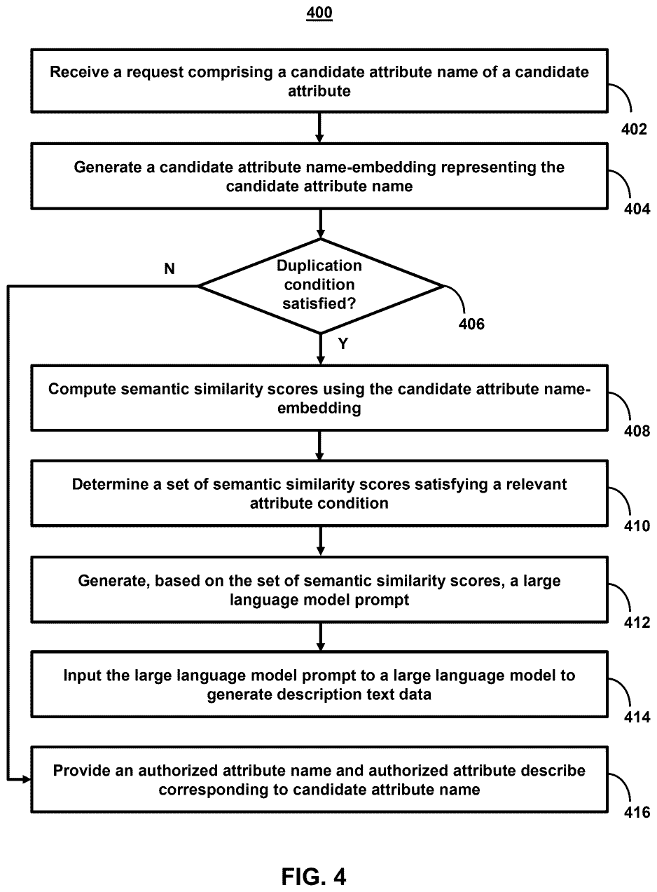

FIG. 4 shows a flowchart of the steps involved in reducing memory consumption by preventing data attribute duplication, in accordance with one or more embodiments. For example, process 400 (e.g., as implemented on one or more system components described above) to facilitate the creation of a data ecosystem including authorized (e.g., standardized, authenticated, etc.), non-duplicative data attribute names and descriptions that follow data governance and compliance rules. In some embodiments, one or more operations of process 400 may be performed by computing system 110. In examples, one or more operations of process 400 may be performed by, or leveraging, one or more machine learning models, such as first LLM 112 and second LLM 128, or other models, or combinations thereof. Further still, one or more operations of process 400 may be performed using additional components, such as a data dictionary (e.g., the same or similar to data dictionary 134), a metadata repository (e.g., the same or similar to metadata repository 136), and the like. The ordering of process 400 is not restricted to the illustrated embodiment, and one or more operations of process 400 may be performed before or after other operations even if, for example, those operations are labeled consecutively.

In some embodiments, process 400 may begin at step 402. At step 402, a request including a candidate attribute name of a candidate attribute may be received. For example, computing system 110 may be configured to receive a request, such as request 102 including candidate attribute name 104. The candidate attribute name can be represented using a text sequence. This text sequence may be input by a user (e.g., using an input device, such as a touchscreen, keyboard, stylus, mouse, etc.). For example, a graphical user interface (e.g., graphical user interface 200) may include a data field (e.g., candidate attribute name data field 202) with which an input text sequence can be input. In some embodiments, the received request (e.g., request 102) may be a request for a model-generated description to be produced for the candidate attribute name (e.g., candidate attribute name 104). In some examples, the request may include, or form a portion of, a prompt for a large language model.

At step 404, a candidate attribute name embedding representing the candidate attribute name may be generated. For example, computing system 110 may be configured to generate a candidate attribute name embedding (e.g., embedding 114) representing the candidate attribute name (e.g., candidate attribute name 104). In some embodiments, a large language model (e.g., first LLM 112) may be used to generate the candidate attribute name embedding. The large language model may use vector sentence transformer embeddings to convert data dictionary terms into numerical representations. For instance, computing system 110 can transform an input text sequence into a vector representation that corresponds to the candidate attribute name embedding. These embeddings can be analyzed against other embeddings to detect related sequences (i.e., text semantically similar).

At step 406, a determination can be made as to whether a duplication condition is satisfied. In some embodiments, computing system 110 can determine whether a duplication condition (based on embedding 114) and a plurality of authenticated attribute embeddings respectively represent a plurality of authenticated attributes. In some examples, an authenticated data dictionary (e.g., data dictionary 134), an authenticated metadata repository (e.g., metadata repository 136), and/or an embedding database can be leveraged to store the authenticated attribute embeddings. These embeddings may be generated in advance or may be created using, for example, first LLM 112. In some cases, a given authenticated attribute name may be input to first LLM 112 to obtain an authenticated attribute name embedding representing the authenticated attribute name. The authenticated attribute name embedding may be stored, for example, using data dictionary 134. In some embodiments, an additional embedding database can store the authenticated attribute name embeddings (as well as, if available, authenticated attribute description embeddings representing authenticated attribute descriptions corresponding to the authenticated attribute names).

In some embodiments, step 406 may include computing system 110 retrieving, accessing, and/or generating, one or more authenticated attribute name embeddings from data dictionary 134. The authenticated attribute name embeddings may correspond to authenticated attribute names of authenticated attributes. The candidate attribute name embedding (e.g., embedding 114) can be compared to the authenticated attribute name embeddings to determine whether the duplication condition has been satisfied. For example, computing system 110 may facilitate computing one or more similarity scores, such as scores 116, comparing embedding 114 to the authenticated attribute name embeddings stored in data dictionary 134. To computing scores 116, computing system 110 can include determining distances in embedding space between embedding 114 and the authenticated attribute name embeddings. In some embodiments, computing system 110 may facilitate computing one or more similarity scores, such as scores 116, comparing embedding 114 to authenticated attribute description embeddings stored in data dictionary 134. The authenticated attribute description embeddings can represent authenticated attribute descriptions corresponding to the authenticated attribute names of the authenticated attributes. Computing scores 116 can include determining distances in embedding space between embedding 114 and the authenticated attribute description embeddings.

In some embodiments, computing system 110 may determine whether the candidate attribute name embedding (e.g., embedding 114) and any of the authenticated attribute name embeddings satisfy the duplication condition. Failing to satisfy the duplication condition can include a similarity score (e.g., from scores 116) that is determined to be greater than or equal to a threshold similarity score, which can also be referred to as a duplication threshold score. The duplication condition can indicate whether any of the authenticated attribute names match an already-existing attribute name of an authenticated attribute (e.g., one available for labeling data items within an enterprise-based metadata management ecosystem). In some examples, the duplication threshold score can be represented as a value between 0 and 100 (e.g., 90% or greater similarity, 95% or greater similarity, 99% or greater similarity, etc.). The duplication threshold score relates to a distance in embedding space indicative of semantic similarity. In embodiments, if not, then the duplication condition can be considered satisfied. By doing so, computing system 110 can ensure that candidate attributes are not duplicated or modeled multiple times across data systems, data ecosystems, or the like. For example, computing system 110 can ensure that candidate attributes are not already modeled in authenticated enterprise data dictionaries. Ensuring that no duplicate attributes are added and eliminating existing duplicate attributes can contribute to a reduction in memory consumption, as duplicative entries across databases can be consolidated.

If, at step 406, it is determined that the duplication condition failed to be satisfied (e.g., a duplication was detected from the existing enterprise metadata), process 400 may proceed to step 416. However, if at step 406 it is determined that the duplication condition was satisfied (e.g., no duplications were detected), process 400 may proceed to step 408.

At step 416, process 400 (e.g., using one or more components described above) can provide an authorized attribute name and an authorized attribute description corresponding to candidate attribute name. For example, following the duplication condition failing to be satisfied, computing system 110 may be configured to determine an authenticated attribute name embedding corresponding to the similarity score that failed to satisfy the duplication condition. The authenticated attribute name embedding can be used to determine an authenticated attribute whose corresponding authenticated attribute name matches the candidate attribute name (e.g., the same or similar to candidate attribute name 104). In some embodiments output 106 may include previously-generated description 108, which represents the already-existing attribute's previously-generated metadata description for an already-existing authenticated attribute name matching candidate attribute name 104.

At step 408, semantic similarity scores may be computed using the candidate attribute name embedding. For example, based on the duplication condition being satisfied, computing system 110 may be configured to compute scores 116. Scores 116 can refer to semantic similarity scores. The semantic similarity scores can indicate how similar the underlying meaning of the candidate attribute name is compared to the contextual meanings of other attribute names (e.g., an authenticated attribute name). For example, computing system 110 may compute scores 116 using embedding 114 representing candidate attribute name 104 and a plurality of authenticated attribute name embeddings representing a plurality of authenticated attribute names, respectively.

At step 410, a set of semantic similarity scores satisfying a relevant attribute condition may be determined. For example, computing system 110 may be configured to determine scores 120 satisfying the relevant attribute condition (so long as at least one is present). In some embodiments, computing system 110 can determine a quantity of samples to include as selectable options for the context (e.g., selectable context 124) based on whether a corresponding score satisfies the relevant attribute condition. In some examples, the set of semantic similarity scores satisfying the relevant attribute condition can include top-K semantic similarity scores (e.g., from scores 120). In some embodiments, determining whether the relevant attribute condition has been satisfied includes computing scores using the candidate attribute name embedding (e.g., embedding 114) and a plurality of non-authenticated attribute name embeddings (e.g., name embeddings 138) and computing scores using the candidate attribute name embedding (e.g., embedding 114) and a plurality of non-authenticated attribute description embeddings (e.g., description embeddings 140). The relevant attribute condition may be analyzed by computing a distance in embedding space between the candidate attribute name embedding and the non-authenticated attribute name embeddings (e.g., name embeddings 138, description embeddings 140). If the distance is less than a threshold distance, this can indicate that the candidate attribute name is semantically similar to a given non-authenticated attribute name and/or non-authenticated attribute description. In some embodiments, computing the relevant attribute condition may include computing an alignment score indicating how well an attribute description describes the candidate attribute name. If the alignment score is high, this can indicate that the non-authenticated attribute description logically and contextually supports the candidate attribute name.

In some embodiment, as detailed further below, satisfying the relevant attribute condition can include allowing user selection of one or more non-authenticated attribute names and/or non-authenticated attribute descriptions. For example, top-K scores may be identified, which indicates the top-K most relevant non-authenticated attribute names and/or non-authenticated attribute descriptions, can be presented via a graphical user interface (e.g., graphical user interface 200 of FIGS. 2A-2C). One or more of the presented relevant context options can be displayed, with each option being one of the top-K most relevant non-authenticated attribute names and/or non-authenticated attribute descriptions. In some embodiments, if no selections are made, each of the top-K most relevant non-authenticated attribute names and/or non-authenticated attribute descriptions may be considered as “satisfying” the relevant attribute condition. For example, this scenario may correspond to a batch or default mode, whereas a user selecting one or more of the top-K most relevant non-authenticated attribute names and/or non-authenticated attribute descriptions may correspond to a dynamic mode.

At step 412, a large language model prompt may be generated based on the set of semantic similarity scores. For example, computing system 110 may be configured to generate a large language model prompt (e.g., prompt 126). The large language model prompt may be generated based on the set of semantic similarity scores (e.g., the same or similar to scores 120). In some examples, the large language model prompt may include the candidate attribute name. In some examples, the large language model prompt may include context (e.g., the same or similar to selectable context 124). The context can include, for instance, a non-authenticated attribute name, a non-authenticated attribute description, or a combination thereof, corresponding to the set of semantic similarity scores. For example, the context may include any of the selected top-K most relevant non-authenticated attribute names and/or non-authenticated attribute descriptions (e.g., options 212 and 214 of FIGS. 2A-2C). In some examples, computing system 110 can retrieve the non-authenticated attribute name or non-authenticated attribute description included in the context from metadata repository 136. For example, the large language model may use the non-authenticated attribute name and non-authenticated attribute descriptions with the highest-ranking semantic similarity scores to build the large language model prompt. In some embodiments, the large language model prompt (e.g., prompt 126) may include a query text sequence and a context text sequence. In examples, the query text sequence can include the candidate attribute name with a request to generate a metadata description for the candidate attribute name so long as no existing authenticated attribute names match. The context text sequence can include any selected or added context, such as the non-authenticated attribute name and/or the non-authenticated attribute description selected from the set of semantic similar scores.

At step 414, the large language model prompt may be input to a large language model to generate description text data. In some examples the description text data can be the same or similar to output 130 and/or model-generated description 132. In some embodiments, computing system 110 may be configured to input the large language model prompt (e.g., prompt 126) to a second large language model (e.g., second LLM 128) to generate the text data. In some embodiments, the second large language model can use Retrieved-Augmented Generation (RAG) to ground responses in existing knowledge or context provided by the large language model prompt, therefore grounding the responses in existing knowledge and preventing hallucinations. For example, the second large language model may take, as input, the large language model prompt, and generate description text data. The description text data may include natural language text describing data items labeled, or to be labeled, with the candidate attribute name.

In embodiment, the description text can comply with any data standards and accurately describe the candidate attribute, as well as align with authorized attributes. Without the use of computing system 110, for example, the accuracy, consistency, and style of text descriptions can be highly dependent on the skill level and subject matter expertise of the data modeler writing the description. Computing system 110 can automatically generate accurate and consistent text descriptions, reducing reliance on human-labelers, thereby reducing or even eliminating avoidable errors and/or bias.

In some embodiments, computing system 110 inputting the large language model prompt to the second large language model may include retrieving metadata rules associated with the natural language text. These metadata rules can specify a structure and format of the natural language text. For example, the metadata rules can be based on metadata governance standards (e.g., naming conventions, privacy classifications, sensitivity indicators). Incorporating the metadata rules in the large language model prompt can allow the second large language model to follow metadata governance policies automatically while creating, modifying, suggesting, etc., any new metadata descriptions. Incorporating metadata rules can also improve model LLM accuracy by structuring prompts effectively and consistently. This is particularly important when dealing with large language models, which can be sensitive to small changes in the input sequence of text.

In some embodiments, computing system 110 may be configured to provide, to a client device, the description text data. For example, the natural language text may be displayed via a graphical user interface (e.g., graphical user interface 142). The graphical user interface, rendered using hardware and software components of the client device, can be used to detect user feedback for the natural language text. For example, the user input can include a user modification to the natural language text can be input using the graphical user interface, and computing system 110 can detect the selection based on the input. For example, the selection could include a portion of natural language text that a user selected as relevant context or irrelevant context. In examples, the user feedback may include historical chat context between a user and the system. In some embodiments, computing system 110 may be configured to generate an updated large language model prompt based on the large language model prompt (e.g., prompt 126), the natural language text (e.g., model-generated description 132), and any the user feedback provided in response to the natural language text. The updated large language model prompt can be input, using computing system 110, to the second large language model (e.g., second LLM 128) to obtain updated description text data. The updated description text data can include, for example, updated natural language text. This updated natural language text can be used to describe data items labeled with the candidate attribute name (e.g., label metadata).

In some embodiments, computing system 110 may be configured to determine an alignment score for the natural language text indicating how closely the natural language text aligns with the context included by the large language model prompt (e.g., prompt 126). For example, the alignment score can be a semantic similarity score (e.g., answer relevancy, correctness, BLEU score, BERT score, etc.) between the natural language text used to describe data items labeled with the candidate attribute and the large language model prompt. In some embodiments, the alignment score can include phrase similarity scores, sentence similarity scores, or textual similarity scores. In some embodiments, if the alignment score is determined to be greater than or equal to an alignment threshold score, then this can indicate that the natural language text aligns with the context. For example, the alignment score threshold can be set by computing system 110 or a user to a level that corresponds to a set level of confidence (e.g., 90%, 99%) that the natural language text aligns with the context.

If the alignment score is determined to be less than an alignment score threshold, indicating that the natural language text fails to align with the context, computing system 110 may be configured to generate an updated large language model prompt (e.g., the same or similar to prompt 126). For example, this updated large language model prompt may include additional context (e.g., added via additional context data field 206). In examples, this context may include additional user modification to the natural language text, such as user modifications input using a graphical user interface (e.g., graphical user interface 142) or user chat history. In some embodiments, computing system 110 may be configured to input the updated large language model prompt to the second large language model to generate updated description text data. In examples, the second large language model incorporating the additional context can result in more relevant updated description with a higher alignment score than the text that the description text data that would have been generated without the additional context. For example, the updated description text data may include updated natural language text, which can be more closely-aligned with the context, enabling iterative metadata generation and refinement.

Furthermore, computing system 110 can generate description text for a candidate attribute that aligns with metadata context by searching across various authenticated and unauthenticated sources of data. Thereby, computing system 110 can effectively be used to authenticate a plurality of unauthenticated dataset (e.g., enterprise databases, data dictionaries, process documents) into a standardized data ecosystem that is fully compliant with governance standards. The standardized data ecosystem can greatly reduce memory storage by authorizing and consolidating unauthorized attribute names and descriptions from unauthorized datasets. For example, the standardized dataset should include no duplicate attributes (e.g., having the same or semantically equivalent attribute name and/or description). Furthermore, the standardized data ecosystem can ensure metadata compliance with regulatory requirements.

In some embodiments, computing system 110 may be configured to train the second large language model. For example, the second large language model (e.g., second LLM 128) may be trained by iteratively providing training prompts (e.g., prompt 126) to the second large language model to generate training descriptions. In embodiments, the second large language model may integrate generative AI (e.g., an LLM) with Retrieval-Augmented Generation (RAG). The provided training prompts can consist of a plurality of authorized attribute names and corresponding authorized attribute descriptions in one or more enterprise databases. For example, the training prompts can also include non-authorized attribute names and corresponding non-authorized attribute descriptions identified to be the most relevant to any authorized attribute names or authorized attribute descriptions. The training prompts can also include context from an enterprise network, chat history, data governance standards, selected input from subject matter experts, and other relevant information, or combinations thereof. This approach can incorporate contextualization such as from an enterprise into the second large language model and can generate higher-quality attribute definition aligning with enterprise standards. An alignment score can be determined based on how closely the training descriptions align with ground truth descriptions associated with the training prompts. For example, one of the ground truth descriptions associated with the training prompts can be an authenticated attribute description and an authenticated attribute description that the second large language model should assign once trained to a training candidate attribute when provided the set of training non-authorized attribute names and corresponding non-authorized attribute descriptions. One or more parameters of the second large language model may be adjusted to minimize a loss function. In examples, the one or more parameters can include connection weights, embedding distances, vector representations, learning rates, etc. For example, the loss function can describe how closely a given training description aligns with a corresponding ground truth description. Training the second large language model such as with RAG can ground responses in existing knowledge and enterprise context, preventing hallucinations and reducing errors. Furthermore, training the second large language model can result in more accurate production of attribute descriptions with fewer iterations, making the metadata creation process more efficient with regards to computing resources and computing storage.

In some embodiments, computing system 110 may be configured to label data items using one or more authenticated attributes. As an example, if a first data item to be labeled is received, a determination of a most appropriate authenticated attribute can be assigned as a label for the first data item. For example, computing system 110 may be configured to determine that the first data item is to be labeled with the candidate attribute. In this example, the first data item can be stored with the candidate attribute name and natural language text (e.g., a model-produced description of the candidate attribute name). For example, the first data item can include the candidate attribute name as a label of a type of data item.

As an illustrative example, computing system 110 may receive one or more to-be-labeled data items, analyze the data items to determine a type of data represented by the data items, one or more categories or topics related to the data items, or other aspects that can be used for data item classification tasks. The classifications (e.g., using first LLM 112), which indicate the attributes with which a given data item is to be labeled, can be determined based on the analysis of the data item (e.g., type of data, categories or topics related, etc.). By doing so, computing system 110 can prepare databases for further downstream data analytics.

In some embodiments, computing system 110 may be configured to facilitate one or more data operations to be performed on, or using, the labeled data. Some example data operations can include data cleaning, structuring, annotating, merging, modeling, or other analyses, or combinations thereof. For example, the data operations could be performed to create a data product, derive data insight operations, guide business decisions, effectuate one or more physical actions or computer programs to be executed. Some examples include creating a data product such as a characterization of the data, a data visualization, or predictive analytics about the data.

As an illustrative example, the data insight operation in an address density visualization request can create a data product that represents an address density visualization to visualize the density of mailing address locations collected by geographic region. In response to receiving the request, computing system 110 may determine one or more attribute names to be analyzed based on the request. For example, computing system 110 may determine the data attribute name “prospect mailing address” within an authorized database such as a standardized ecosystem should be analyzed based on the address density visualization request. If the request identifies the candidate attribute as relevant, the first data item may be retrieved based on the first data item having the candidate attribute name stored therewith as a label. The address density visualization can find the contents of the unauthenticated data attributes named “mailing address” relevant, and the computing system can retrieve the unauthenticated data attributes stored with the label “prospect mailing address.” Thus, computing system 110 may be configured to execute the data insight operations to one or more data items including the first data item, where these data items include the candidate attribute name as a label indicating that these data items correspond to the candidate attribute. For example, a data visualization could be performed using the unauthenticated data attributes named “mailing address” stored with the label “prospect mailing address.” By doing so, the system can prepare data from various datasets, whether unauthorized or authorized, for data operations such as data analysis within a standardized data ecosystem. This computing system can perform data analysis and produce data products with much less computer memory, computer processing power, and feedback from subject matter experts compared to conventional systems.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in any of FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A system for reducing memory consumption by preventing duplicative data attribute names and descriptions.
2. The method of claim 1, comprising: receiving a request comprising a candidate attribute name of a candidate attribute for which a model-generated description is to be produced; generating, using a first large language model, a candidate attribute name embedding representing the candidate attribute name; based on the candidate attribute name embedding and a plurality of authenticated attribute embeddings, respectively representing a plurality of authenticated attributes, satisfying a duplication condition, computing (i) first semantic similarity scores using the candidate attribute name embedding and a plurality of non-authenticated attribute name embeddings and (ii) second semantic similarity scores using the candidate attribute name embedding and a plurality of non-authenticated attribute description embeddings; determining, from the first semantic similarity scores and the second semantic similarity scores, a set of semantic similarity scores satisfying a relevant attribute condition; generating, based on the set of semantic similarity scores, a large language model prompt comprising (a) the candidate attribute name and (b) context comprising at least one of a non-authenticated attribute name or a non-authenticated attribute description corresponding to the set of semantic similarity scores; and inputting the large language model prompt to a second large language model to generate description text data comprising natural language text describing data items labeled with the candidate attribute name.
3. The method of embodiment 2, wherein determining the set of semantic similarity scores satisfying the relevant attribute condition comprises: determining a quantity of samples to include as selectable options for the context; and selecting, based on the first semantic similarity scores and the second semantic similarity scores, the set of semantic similarity scores to have a quantity equal to the quantity of samples.
4. The method of embodiment 3, wherein generating the large language model prompt comprises: creating the large language model prompt comprising a query text sequence representing the candidate attribute name and a context text sequence representing the at least one of (a) the non-authenticated attribute name or (b) the non-authenticated attribute description.
5. The method of any one of embodiments 2-4, wherein generating the large language model prompt comprises: determining a subset of non-authenticated attribute names and a subset of non-authenticated attribute descriptions corresponding to the set of semantic similarity scores; and providing, via a graphical user interface, the subset of non-authenticated attribute names and the subset of non-authenticated attribute descriptions.
6. The method of embodiment 5, wherein generating the large language model prompt comprises: determining a selection of the at least one of the non-authenticated attribute name or the non-authenticated attribute description; and creating the large language model prompt based on the selection.
7. The method of any one of embodiments 2-6, further comprising: determining that the candidate attribute name embedding and a plurality of authenticated attribute name embeddings satisfy the duplication condition; and determining, based on the duplication condition being satisfied, that a plurality of authenticated attribute names respectively corresponding to the plurality of authenticated attribute name embeddings do not include the candidate attribute name.
8. The method of any one of embodiments 2-7, wherein the request comprises a first request, the candidate attribute name comprises a first candidate attribute name, the model-generated description comprises a first model-generated description, and the candidate attribute name embedding comprises a first candidate attribute name embedding, the method further comprises: receiving a second request comprising a second candidate attribute name for which a second model-generated description is to be produced; generating, using the first large language model, a second candidate attribute name embedding representing the second candidate attribute name; computing a plurality of similarity scores indicating a similarity of the second candidate attribute name embedding to the plurality of authenticated attribute embeddings; identifying a similarity score failing to satisfy the duplication condition; determining an authenticated attribute name embedding corresponding to the similarity score satisfying the duplication condition, wherein the authenticated attribute name embedding corresponds to an authenticated attribute name of an authenticated attribute.
9. The method of embodiment 8, further comprising: providing, via a graphical user interface, a graphical representation of the authenticated attribute including the authenticated attribute name and a corresponding authenticated attribute description; and determining, based on an option displayed via the graphical user interface to use the authenticated attribute name and the corresponding authenticated attribute description as a label for data items in lieu of the second candidate attribute name being selected, that the candidate attribute name corresponds to an already-existing attribute name.
10. The method of any one of embodiments 2-9, wherein computing the first semantic similarity scores and the second semantic similarity scores comprises: determining a first plurality of distances between the candidate attribute name embedding and the plurality of non-authenticated attribute name embeddings to identify non-authenticated attribute names semantically similar to the candidate attribute name; and determining a second plurality of distances between the candidate attribute name embedding and the plurality of non-authenticated attribute description embeddings to identify non-authenticated attribute descriptions that are semantically similar to the candidate attribute name.
11. The method of embodiment 10, wherein determining the set of semantic similarity scores satisfying the relevant attribute condition comprises: determining at least one distance from the first plurality of distances or the second plurality of distances that is less than a threshold embedding space distance; and selecting the set of semantic similarity scores based on the at least one distance from the first plurality of distances or the second plurality of distances that is determined to be less than the threshold embedding space distance.
12. The method of any one of embodiments 2-11, wherein computing the first semantic similarity scores and the second semantic similarity scores comprises: determining, based on the candidate attribute name embedding and the plurality of non-authenticated attribute name embeddings, a first plurality of similarity scores indicating one or more first non-authenticated attribute names matching the candidate attribute name; determining, based on the candidate attribute name embedding and the plurality of non-authenticated attribute description embeddings, a second plurality of similarity scores indicating one or more first non-authenticated attribute descriptions semantically describing the candidate attribute name; identifying, based on the first plurality of similarity scores and the second plurality of similarity scores, (1) one or more second non-authenticated attribute names that (1)(a) were not determined to match the candidate attribute name and (1)(b) correspond to at least one of the one or more first non-authenticated attribute descriptions or (2) one or more second non-authenticated attribute descriptions that (2)(a) were not determined to semantically describe the candidate attribute name and (2)(b) correspond to at least one of the one or more first non-authenticated attribute descriptions.
13. The method of embodiment 12, wherein determining the set of semantic similarity scores satisfying the relevant attribute condition comprising: assigning first weights to a first set of similarity scores from the first plurality of similarity scores corresponding to the one or more first non-authenticated attribute names and the one or more first non-authenticated attribute descriptions; assigning second weights to a second set of similarity scores from the second plurality of similarity scores corresponding to the one or more second non-authenticated attribute names and the one or more second non-authenticated attribute descriptions; and selecting the set of semantic similarity scores based on the first set of similarity scores having the first weights and the second set of similarity scores having the second weights, wherein satisfying the relevant attribute condition comprises a weighted similarity score being greater than or equal to a threshold similarity score.
14. The method of any one of embodiments 2-13, wherein inputting the large language model prompt comprises: determining one or more metadata rules associated with the natural language text, the one or more metadata rules specifying a structure and format of the natural language text; and updating the large language model prompt to include the one or more metadata rules.
15. The method of any one of embodiments 2-14, further comprising: providing, to a client device, the description text data such that the natural language text is displayed via a graphical user interface; detecting, using the graphical user interface, user feedback for the natural language text; generating an updated large language model prompt based on the large language model prompt, the natural language text, and the user feedback; and inputting the updated large language model prompt to the second large language model to obtain updated description text data comprising updated natural language text describing data items labeled with the candidate attribute name.
16. The method of any one of embodiments 2-15, further comprising: training the second large language model by iteratively: providing training prompts to the second large language model to generate training descriptions; determining an alignment score based on how closely the training descriptions align with ground truth descriptions associated with the training prompts; and adjusting one or more parameters of the second large language model to minimize a loss function.
17. The method of any one of embodiments 2-16, further comprising: receiving a first data item to be labeled; determining the first data item is to be labeled with the candidate attribute; and storing the first data item with the candidate attribute name and natural language text.
18. The method of embodiment 17, further comprising: receiving a request to execute data insight operations; determining attribute names to be analyzed based on the request; retrieving the first data item based on the candidate attribute name; and executing the data insight operations to one or more data items including the first data item.
19. The method of any one of embodiments 2-18, further comprising: determining an alignment score for the natural language text indicating how closely the natural language text aligns with the context included by the large language model prompt; generating an updated large language model prompt comprising additional context based on the alignment score being less than an alignment score threshold indicating that the natural language text fails to align with the context; and inputting the updated large language model prompt to the second large language model to generate updated description text data comprising updated natural language text.
20. The method of any one of claims 2-19, wherein generating the candidate attribute-name embedding comprises generating the candidate attribute name embedding responsive to receiving the request for the model-generated description.
21. The method of any one of claims 2-20, wherein the method is further configured to authorize and consolidate unauthorized attribute names and descriptions using large language models.
22. The method of any one of claims 2-21, wherein the method is further configured to and enhance network security network labeling.
23. The method of any one of claims 2-22, further comprising: storing, using cloud-based memory, (a) the plurality of authenticated attributes, (b) the plurality of non-authenticated attributes, and (c) the plurality of embeddings, wherein the plurality of authenticated attributes comprise authenticated attribute names and authenticated attribute descriptions, wherein the plurality of non-authenticated attributes comprise non-authenticated attribute names and non-authenticated attribute descriptions, and wherein the plurality of embeddings comprises authenticated attribute name embeddings representing the authenticated attribute names, authenticated attribute description embeddings representing the authenticated attribute descriptions, non-authenticated attribute name embeddings representing the non-authenticated attribute names, and non-authenticated attribute description embeddings representing the non-authenticated attribute descriptions.
24. A system for reducing memory consumption by preventing duplicative data attribute names and descriptions, authorizing and consolidating unauthorized attribute names and descriptions using large language models, and enhancing network security network labeling, comprising: cloud-based memory that stores (a) a plurality of authenticated attributes, (b) a plurality of non-authenticated attributes, and (c) a plurality of embeddings, wherein the plurality of authenticated attributes comprise authenticated attribute names and authenticated attribute descriptions, wherein the plurality of non-authenticated attributes comprise non-authenticated attribute names and non-authenticated attribute descriptions, and wherein the plurality of embeddings comprises authenticated attribute name embeddings representing the authenticated attribute names, authenticated attribute description embeddings representing the authenticated attribute descriptions, non-authenticated attribute name embeddings representing the non-authenticated attribute names, and non-authenticated attribute description embeddings representing the non-authenticated attribute descriptions; cloud-based control circuitry configured to: receive an input text sequence representing a candidate attribute name with which a model-generated description is to be produced; generate, using a first large language model, a candidate attribute name embedding representing the input text sequence; compute first authenticated similarity scores based on a distance between the candidate attribute name embedding and the authenticated attribute name embeddings and second authenticated similarity scores indicating based on a distance between the candidate attribute name embedding and the authenticated attribute description embeddings; responsive to determining that the first authenticated similarity scores and the second authenticated similarity scores satisfy a duplication condition indicating that the candidate attribute name does not represent a duplication of any of the authenticated attribute names or the authenticated attribute descriptions, wherein satisfying the duplication condition comprises a similarity score being less than a first threshold similarity score, compute first semantic similarity scores based on a distance between the candidate attribute name embedding and the non-authenticated attribute name embeddings and second semantic similarity scores based on a distance between the candidate attribute name embedding and the non-authenticated attribute description embeddings; determine, from the first semantic similarity scores and the second semantic similarity scores, a set of semantic similarity scores satisfying a relevant attribute condition indicating that the candidate attribute name is contextually related to a corresponding non-authenticated attribute name or non-authenticate attribute description, wherein satisfying the relevant attribute condition comprises a semantic similarity score being greater than or equal to a second threshold similarity score; generate the set of semantic similarity scores, a large language model prompt comprising the candidate attribute name and context comprising at least one non-authenticated attribute name or non-authenticated attribute description corresponding to the set of semantic similarity scores; and input the large language model prompt to a second large language model to generate description text data comprising natural language text describing data items labeled with the candidate attribute name.
25. A method, comprising: responsive to receiving a request for a model-generated description based on a candidate attribute name, generating, using a first large language model, a candidate attribute name embedding representing the candidate attribute name; computing (i) first semantic similarity scores using the candidate attribute name embedding and a plurality of non-authenticated attribute name embeddings and (ii) second semantic similarity scores using the candidate attribute name embedding and a plurality of non-authenticated attribute description embeddings; determining, from the first semantic similarity scores and the second semantic similarity scores, a set of semantic similarity scores satisfying a relevant attribute condition; and generating, based on the set of semantic similarity scores, a large language model prompt comprising (a) the candidate attribute name and (b) context comprising at least one of a non-authenticated attribute name or a non-authenticated attribute description corresponding to the set of semantic similarity scores.
26. One or more non-transitory, computer-readable mediums storing instructions that, when executed by a data processing apparatus, cause the data processing apparatus to perform operations comprising those of any of embodiments 1-25.
27. A system comprising one or more processors; and memory storing instructions that, when executed by the processors, cause the processors to effectuate operations comprising those of any of embodiments 1-25.
28. A system comprising means for performing any of embodiments 1-25.

What is claimed is:

1. A system for reducing memory consumption by preventing duplicative data attribute names and descriptions, authorizing and consolidating unauthorized attribute names and descriptions using large language models, and enhancing network security network labeling, comprising:
cloud-based memory that stores (a) a plurality of authenticated attributes, (b) a plurality of non-authenticated attributes, and (c) a plurality of embeddings, wherein the plurality of authenticated attributes comprise authenticated attribute names and authenticated attribute descriptions, wherein the plurality of non-authenticated attributes comprise non-authenticated attribute names and non-authenticated attribute descriptions, and wherein the plurality of embeddings comprises authenticated attribute name embeddings representing the authenticated attribute names, authenticated attribute description embeddings representing the authenticated attribute descriptions, non-authenticated attribute name embeddings representing the non-authenticated attribute names, and non-authenticated attribute description embeddings representing the non-authenticated attribute descriptions; and
cloud-based control circuitry configured to:
receive an input text sequence representing a candidate attribute name with which a model-generated description is to be produced;
generate, using a first large language model, a candidate attribute name embedding representing the input text sequence;
compute first authenticated similarity scores based on a distance between the candidate attribute name embedding and the authenticated attribute name embeddings and second authenticated similarity scores indicating based on a distance between the candidate attribute name embedding and the authenticated attribute description embeddings;
responsive to determining that the first authenticated similarity scores and the second authenticated similarity scores satisfy a duplication condition indicating that the candidate attribute name does not represent a duplication of any of the authenticated attribute names or the authenticated attribute descriptions, wherein satisfying the duplication condition comprises a similarity score being less than a first threshold similarity score, compute first semantic similarity scores based on a distance between the candidate attribute name embedding and the non-authenticated attribute name embeddings and second semantic similarity scores based on a distance between the candidate attribute name embedding and the non-authenticated attribute description embeddings;
determine, from the first semantic similarity scores and the second semantic similarity scores, a set of semantic similarity scores satisfying a relevant attribute condition indicating that the candidate attribute name is contextually related to a corresponding non-authenticated attribute name or non-authenticate attribute description, wherein satisfying the relevant attribute condition comprises a semantic similarity score being greater than or equal to a second threshold similarity score;
generate the set of semantic similarity scores, a large language model prompt comprising the candidate attribute name and context comprising at least one non-authenticated attribute name or non-authenticated attribute description corresponding to the set of semantic similarity scores; and
input the large language model prompt to a second large language model to generate description text data comprising natural language text describing data items labeled with the candidate attribute name.

2. A method, implemented using one or more processors of a computing system, the method comprising:
receiving a request comprising a candidate attribute name of a candidate attribute for which a model-generated description is to be produced;
generating, using a first large language model, a candidate attribute name embedding representing the candidate attribute name;
based on the candidate attribute name embedding and a plurality of authenticated attribute embeddings, respectively representing a plurality of authenticated attributes, satisfying a duplication condition, computing (i) first semantic similarity scores using the candidate attribute name embedding and a plurality of non-authenticated attribute name embeddings and (ii) second semantic similarity scores using the candidate attribute name embedding and a plurality of non-authenticated attribute description embeddings;
determining, from the first semantic similarity scores and the second semantic similarity scores, a set of semantic similarity scores satisfying a relevant attribute condition;
generating, based on the set of semantic similarity scores, a large language model prompt comprising (a) the candidate attribute name and (b) context comprising at least one of a non-authenticated attribute name or a non-authenticated attribute description corresponding to the set of semantic similarity scores; and
inputting the large language model prompt to a second large language model to generate description text data comprising natural language text describing data items labeled with the candidate attribute name.

3. The method of claim 2, wherein determining the set of semantic similarity scores satisfying the relevant attribute condition comprises:
determining a quantity of samples to include as selectable options for the context; and
selecting, based on the first semantic similarity scores and the second semantic similarity scores, the set of semantic similarity scores to have a quantity equal to the quantity of samples.

4. The method of claim 3, wherein generating the large language model prompt comprises:
determining a query text sequence representing the candidate attribute name and a context text sequence representing the at least one of (a) the non-authenticated attribute name or (b) the non-authenticated attribute description; and
creating the large language model prompt comprising the query text sequence.

5. The method of claim 2, wherein generating the large language model prompt comprises:
determining a subset of non-authenticated attribute names and a subset of non-authenticated attribute descriptions corresponding to the set of semantic similarity scores; and
providing, via a graphical user interface, the subset of non-authenticated attribute names and the subset of non-authenticated attribute descriptions.

6. The method of claim 5, wherein generating the large language model prompt comprises:
determining a selection of the at least one of the non-authenticated attribute name or the non-authenticated attribute description; and
creating the large language model prompt based on the selection.

7. The method of claim 2, further comprising:
determining that the candidate attribute name embedding and a plurality of authenticated attribute name embeddings satisfy the duplication condition; and
determining, based on the duplication condition being satisfied, that a plurality of authenticated attribute names respectively corresponding to the plurality of authenticated attribute name embeddings do not include the candidate attribute name.

8. The method of claim 2, wherein the request comprises a first request, the candidate attribute name comprises a first candidate attribute name, the model-generated description comprises a first model-generated description, and the candidate attribute name embedding comprises a first candidate attribute name embedding, the method further comprises:
receiving a second request comprising a second candidate attribute name for which a second model-generated description is to be produced;
generating, using the first large language model, a second candidate attribute name embedding representing the second candidate attribute name;
computing a plurality of similarity scores indicating a similarity of the second candidate attribute name embedding to the plurality of authenticated attribute embeddings;
identifying a similarity score failing to satisfy the duplication condition;
determining an authenticated attribute name embedding corresponding to the similarity score satisfying the duplication condition, wherein the authenticated attribute name embedding corresponds to an authenticated attribute name of an authenticated attribute.

9. The method of claim 8, further comprising:
providing, via a graphical user interface, a graphical representation of the authenticated attribute including the authenticated attribute name and a corresponding authenticated attribute description; and
determining, based on an option displayed via the graphical user interface to use the authenticated attribute name and the corresponding authenticated attribute description as a label for data items in lieu of the second candidate attribute name being selected, that the candidate attribute name corresponds to an already-existing attribute name.

10. The method of claim 2, wherein computing the first semantic similarity scores and the second semantic similarity scores comprises:
determining a first plurality of distances between the candidate attribute name embedding and the plurality of non-authenticated attribute name embeddings to identify non-authenticated attribute names semantically similar to the candidate attribute name; and
determining a second plurality of distances between the candidate attribute name embedding and the plurality of non-authenticated attribute description embeddings to identify non-authenticated attribute descriptions that are semantically similar to the candidate attribute name.

11. The method of claim 10, wherein determining the set of semantic similarity scores satisfying the relevant attribute condition comprises:
determining at least one distance from the first plurality of distances or the second plurality of distances that is less than a threshold embedding space distance; and
selecting the set of semantic similarity scores based on the at least one distance from the first plurality of distances or the second plurality of distances that is determined to be less than the threshold embedding space distance.

12. The method of claim 2, wherein computing the first semantic similarity scores and the second semantic similarity scores comprises:
determining, based on the candidate attribute name embedding and the plurality of non-authenticated attribute name embeddings, a first plurality of similarity scores indicating one or more first non-authenticated attribute names matching the candidate attribute name;
determining, based on the candidate attribute name embedding and the plurality of non-authenticated attribute description embeddings, a second plurality of similarity scores indicating one or more first non-authenticated attribute descriptions semantically describing the candidate attribute name;
identifying, based on the first plurality of similarity scores and the second plurality of similarity scores, (1) one or more second non-authenticated attribute names that (1)(a) were not determined to match the candidate attribute name and (1)(b) correspond to at least one of the one or more first non-authenticated attribute descriptions or (2) one or more second non-authenticated attribute descriptions that (2)(a) were not determined to semantically describe the candidate attribute name and (2)(b) correspond to at least one of the one or more first non-authenticated attribute descriptions.

13. The method of claim 12, wherein determining the set of semantic similarity scores satisfying the relevant attribute condition comprising:
assigning first weights to a first set of similarity scores from the first plurality of similarity scores corresponding to the one or more first non-authenticated attribute names and the one or more first non-authenticated attribute descriptions;
assigning second weights to a second set of similarity scores from the second plurality of similarity scores corresponding to the one or more second non-authenticated attribute names and the one or more second non-authenticated attribute descriptions; and
selecting the set of semantic similarity scores based on the first set of similarity scores having the first weights and the second set of similarity scores having the second weights, wherein satisfying the relevant attribute condition comprises a weighted similarity score being greater than or equal to a threshold similarity score.

14. The method of claim 2, wherein inputting the large language model prompt comprises:
determining one or more metadata rules associated with the natural language text, the one or more metadata rules specifying a structure and format of the natural language text; and
updating the large language model prompt to include the one or more metadata rules.

15. The method of claim 2, further comprising:
providing, to a client device, the description text data such that the natural language text is displayed via a graphical user interface;
detecting, using the graphical user interface, user feedback for the natural language text;
generating an updated large language model prompt based on the large language model prompt, the natural language text, and the user feedback; and
inputting the updated large language model prompt to the second large language model to obtain updated description text data comprising updated natural language text describing data items labeled with the candidate attribute name.

16. The method of claim 2, further comprising:
training the second large language model by iteratively:
providing training prompts to the second large language model to generate training descriptions;
determining an alignment score based on how closely the training descriptions align with ground truth descriptions associated with the training prompts; and
adjusting one or more parameters of the second large language model to minimize a loss function.

17. The method of claim 2, further comprising:
receiving a first data item to be labeled;
determining the first data item is to be labeled with the candidate attribute; and
storing the first data item with the candidate attribute name and natural language text.

18. The method of claim 17, further comprising:
receiving a request to execute data insight operations;
determining attribute names to be analyzed based on the request;
retrieving the first data item based on the candidate attribute name; and
executing the data insight operations to one or more data items including the first data item.

19. The method of claim 2, further comprising:
determining an alignment score for the natural language text indicating how closely the natural language text aligns with the context included by the large language model prompt;
generating an updated large language model prompt comprising additional context based on the alignment score being less than an alignment score threshold indicating that the natural language text fails to align with the context; and
inputting the updated large language model prompt to the second large language model to generate updated description text data comprising updated natural language text.

20. One or more non-transitory, computer-readable media storing computer program instructions that, when executed by one or more processors, effectuate operations comprising:
responsive to receiving a request for a model-generated description based on a candidate attribute name, generating, using a first large language model, a candidate attribute name embedding representing the candidate attribute name;
computing (i) first semantic similarity scores using the candidate attribute name embedding and a plurality of non-authenticated attribute name embeddings and (ii) second semantic similarity scores using the candidate attribute name embedding and a plurality of non-authenticated attribute description embeddings;
determining, from the first semantic similarity scores and the second semantic similarity scores, a set of semantic similarity scores satisfying a relevant attribute condition; and
generating, based on the set of semantic similarity scores, a large language model prompt comprising (a) the candidate attribute name and (b) context comprising at least one of a non-authenticated attribute name or a non-authenticated attribute description corresponding to the set of semantic similarity scores.
